(19) United States
(12) Patent Application Publication
(10) Pub. No.: US 2006/0010025 A1
(43) Pub. Date: Jan. 12, 2006

(54) E-mail notification support for workflows

(75) Inventors: Juergen Sattler, Wiesloch (DE); Joachim Gaffga, Wiesloch (DE)

Correspondence Address: KENYON & KENYON, 1500 K STREET NW, SUITE 700, WASHINGTON, DC, 20005, US

(73) Assignee: SAP Aktiengesellschaft

(21) Appl. No.: 11/052,770

(22) Filed: Feb. 9, 2005

Related U.S. Application Data
(60) Provisional application No. 60/586,231, filed on Jul. 9, 2004.
(60) Provisional application No. 60/623,872, filed on Nov. 2, 2004.

(51) Int. Cl. G06Q 10/00

(52) U.S. Cl. 705/9

(57) ABSTRACT

An embodiment of the present invention provides a collaboration system and method that includes automatic notifications for tasks as they become active in a workflow. When a first task of the workflow is completed, the computer system receives a notification from a first operator indicating that the first task is done. The computer system then identifies a person, who is responsible for performing a next task in the workflow sequence, and automatically generates a new e-mail notification. The computer system may then send the new notification for the next task to the identified operator of the next task. In one embodiment, the next task may be e-mailed to the recipient and get integrated into the recipient's backend system when a send button is pressed. In other instances, the next task may be attached to an e-mail and further may be integrated into the recipient's backend system if the next task is scanned by a groupware server when the user is online. When the next task is marked as completed, a notification, which records completion of the task, may be returned to the computer system. This process may continue recursively until the workflow reaches its conclusion.

### RELATED APPLICATIONS

Priority is claimed from U.S. Provisional Application No. 60/586,231 filed Jul. 9, 2004 and U.S. Provisional Application No. 60/623,872 filed Nov. 2, 2004.

### BACKGROUND

The present invention relates to collaboration systems and methods that provide a guided framework for handling business workflows. In particular, the present invention relates to collaboration systems and methods with e-mail notification support for business workflows.

Collaboration systems support a variety of business processes, or “workflows,” that are to be performed by one or more individuals within a business organization via the corporate network. These collaboration systems share workflows that typically define incremental process steps or tasks of some business function to be performed among the business actors. A Customer Relationship Management (CRM) system and an Enterprise Resource Planning system are examples of such collaboration systems. When stored by the CRM system, for example, the workflows remain in a workflow repository. To perform a business function, a system operator opens an instance of the workflow in the collaboration system (e.g., the CRM or ERP system). With reference to the workflow, the collaboration system guides the operator through the various tasks that must be performed to complete the business operation.

One or more different tasks are often performed by different actors within one or more business organizations. When a person completes a first task, manual effort is required to notify the next person responsible for a subsequent task indicating that the subsequent task is now active. This manual process may be time consuming and is prone to errors.

Accordingly, there is a need in the art for collaboration systems and methods with e-mail notification support for processing business workflows.

### BRIEF DESCRIPTION OF THE DRAWINGS

FIG. 1 is a block diagram of a computer system with e-mail notification support according to an embodiment of the present invention.

FIG. 2 is a communication flow diagram of a computer system with e-mail notification support according to an embodiment of the present invention.

FIG. 3 is a flowchart illustrating a method for providing e-mail notification for a computer system according to an embodiment of the present invention.

FIG. 4 is a flowchart illustrating a method for providing e-mail notification for a computer system according to another embodiment of the present invention.

### DETAILED DESCRIPTION

The present invention provides a collaboration system and method with e-mail notification support. In particular, an embodiment of the present invention provides a collaboration system and method that includes automatic notifications for tasks as they become active in a workflow. When a first task of the workflow is completed, the computer system receives a notification from a first operator indicating that the first task is done. The computer system then identifies a person, who is responsible for performing a next task in the workflow sequence, and automatically generates a new e-mail notification. The computer system may then send the new notification for the next task to the identified operator of the next task. In one embodiment, the next task may be e-mailed to the recipient's mail box and further may be integrated into the recipient's backend system when a send button is pressed. In another instances, the next task may be attached to an e-mail and further may be integrated into the recipient's backend or local system if the attached new task is scanned by a groupware server when the user reconnects to the network. When the next task is marked as completed, a notification, which records completion of the task, may be returned to the computer system. This process may continue recursively until the workflow reaches its conclusion.

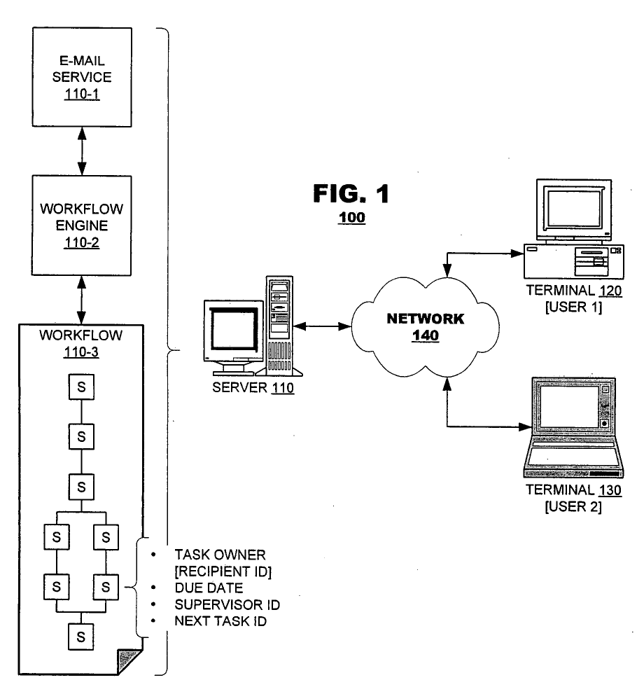

FIG. 1 is a block diagram of a computer system with e-mail notification support 100 according to an embodiment of the present invention. The system 100 may include one or more servers 110 (only one shown). Each server 110 may be in communication with multiple user terminals 120, 130 via a communication network 140, such as the Internet or a corporate Intranet. The server 110 may include an e-mail server 110-1 and a workflow engine 110-2, which may be part of a Customer Relationship Management (CRM) system, for example. The server 110 also may store one or more workflows 110-3 in a workflow repository (not shown separately in FIG. 1). The workflows may map predefined business processes and set forth tasks to be performed, rules of operation, and/or other useful information in performing the workflow.

Each workflow 110-3 may include a number of interconnected stages S that are to be performed consecutively by one or more users. Each stage S may define a task to be performed and a task owner who is designated to perform the task. In one embodiment of the present invention, the task owner may be identified by a user identifier (user ID), a user role identifier (role ID), or a group identifier (group ID). The stage S also may define a due date of the task and/or the workflow, a supervisor identifier (Supervisor ID), a next task identifier (next task ID), and the like. According to an embodiment of the present invention, the due date may be defined as an offset from the start date. The supervisor ID may identify a supervisor who is responsible for managing the workflow. The next task ID may identify which task(s) are to be performed after the current task is completed. The workflow 110-3 also may include one or more stages that are to be performed in parallel by different users. Each task may be performed by one or more individual users, a group, and/or any member(s) of the group.

According to an embodiment of the present invention, when a workflow instance is loaded, the workflow engine 110-2 may manage operation of the workflow and transmission of automatic notifications for tasks as they become active. In particular, when a workflow instance begins, the workflow engine 110-2 automatically may generate an e-mail notification and call the e-mail service 110-1 to send the notification to the first task owner along with the first task. Upon completion of the first task, the first task owner may send a notification to the workflow engine 110-2. The workflow engine 110-2 may then determine a next task and its task owner by referring to the workflow 110-3 stored in the workflow repository. Thereafter, the workflow engine 110-2 automatically may generate an e-mail notification to the next task owner and call the e-mail service 110-1 to transmit the notification.

When called by the workflow engine 110-2, the e-mail service 110-1 may receive and transmit e-mails to intended recipients at user terminals 120, 130 via communication network 140. According to an embodiment, the e-mail engine 110-2 may be any messaging system that may preferably allow document sharing and document management, group calendaring and scheduling, group contact and task management, threaded discussions, text chat, data conferencing, audio- and video-conferencing, and/or the like. For example, a groupware product may be used to provide communication (e.g., Microsoft Windows Messaging, Microsoft Outlook, Lotus Notes, Exchange Client for Windows, and the like).

According to an embodiment of the present invention, each stage may have a generic format such as extensible markup language (XML). As such, the supervisor may modify the workflows 110-3, or any stages therein, before or during operation of the workflow. The computer system 100 also may allow each task owner to modify specific steps within the task assigned to the task owner or its path. In such cases, the computer system 100 may monitor and notify the supervisor of such modifications. Additionally, the computer system 100 may require each completed task to be approved by the supervisor before a notification is sent to the next task owner. Alternatively, such a review process may be predefined as one or more stages of a workflow. The computer system 100 also may send progress reports to the supervisor. Typically, the computer system 100 may identify who may modify the workflows, or any part thereof, and who may receive notifications regarding modifications to the workflows and/or progress reports.

According to an embodiment of the present invention, the workflow may be managed on a common server. In other instances, the workflow may be managed via multiple servers. Such implementation differences are immaterial to the present discussion. FIG. 1 illustrates a single server management merely to facilitate presentation of the present invention.

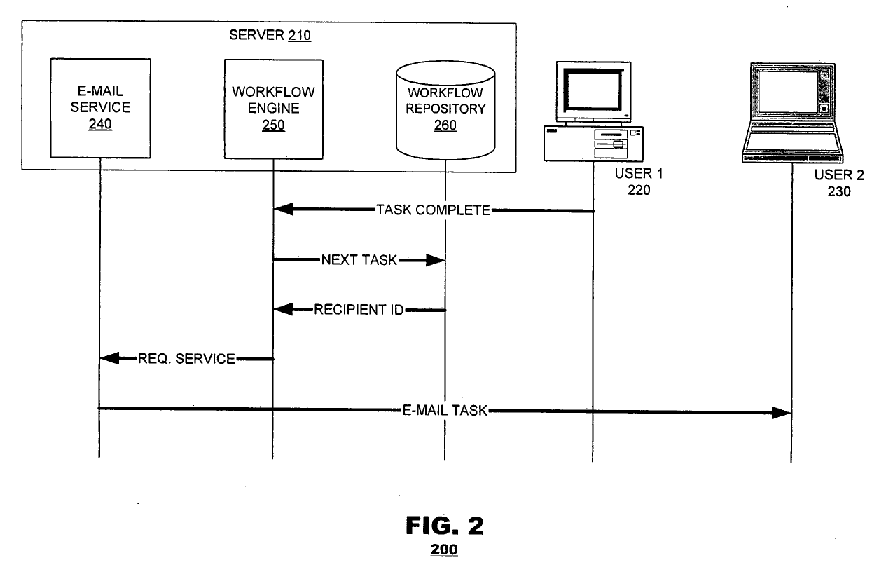

FIG. 2 is a data flow diagram illustrating communication flow of a collaboration system 200 among a server 210, a first user terminal 220, and a second user terminal 230 according to an embodiment of the present invention. The server 210 may include an e-mail service 240, a workflow engine 250, and a workflow repository 260. As mentioned above, the server 210 may communicate with the first and second user terminal 220, 230 via a communication network.

Interaction typically begins when a first user terminal 220 sends a notification to the workflow engine 250 indicating that a task is complete. The notification may identify the workflow with a workflow identifier (workflow ID) and a task that is completed by a task identifier (task ID). The workflow engine 250 may refer to the workflow repository 260 to determine a next task and a next task owner. For example, the workflow engine 250 may locate the workflow instance stored in the workflow repository 260 by looking up the workflow ID and determine the next task and the next task owner by comparing by the task ID and a recipient e-mail address and/or identifier (recipient ID). The workflow engine 250 may then request the e-mail service 240 to transmit a notification of the next task to a new recipient. The e-mail service 240 may then send a notification to the next task owner at the second user terminal 230. As described above, the new task may be sent as an e-mail to a special mail box and further may be incorporated into the recipient's system when the recipient opens the e-mail. In other instances, the new task may be attached to an e-mail and further may be incorporated into the recipient's system if the attachment is scanned by a groupware server when the user reconnects to the network. This process may continue recursively until all stages of the workflow are completed.

Typically, a workflow instance begins when the supervisor chooses to perform the workflow, or when triggered by completion of other, related workflows. Additionally, the workflow engine 250 may be designed to respond to errors and exceptions in other, existing business processes. In such instances, a workflow may begin when predefined events occur. For example, a workflow instance, or a task therein, can be triggered if particular errors are found during an automatic check.

According to an embodiment of the present invention, the collaboration system 200 may provide a synchronization unit (not shown) to facilitate synchronization with workflow applications of different users. In other instances, the collaboration system 200 may support online/offline handling of the workflow. For example, as the workflow engine 250 transmits a task to its task owner, the task may be copied and stored in internal storage or internal tables. The task owner may then retrieve the task from internal storage and perform the task offline. When the task owner reconnects its user terminal to the network, information regarding the task may be submitted to the collaboration system 200 and the task may be synchronized with its workflow.

Offline support also may include a conflict resolution manager (not shown) to facilitate synchronization of data and objects within a workflow. For example, a task may be assigned to an operator who connects to the network on an intermittent basis, for example, via a laptop. Conflicts may arise if, for example, an off-line user changes a workflow object by completing a task and, while the user is off line, another operator changes another object in the workflow. For example, the task also may be completed by another user or the task may be reassigned or opened by another user.

When the offline user returns to the system, a synchronization operation may be performed upon the workflow objects. A conflict may be identified if time stamps of the objects are different between the two systems or if object histories indicate that modifications occurred on each system. In such a case, a conflict resolution manager may be opened. The conflict resolution manager may query, for example, a system operator to select which data and object fields within the objects should be imparted into the system.

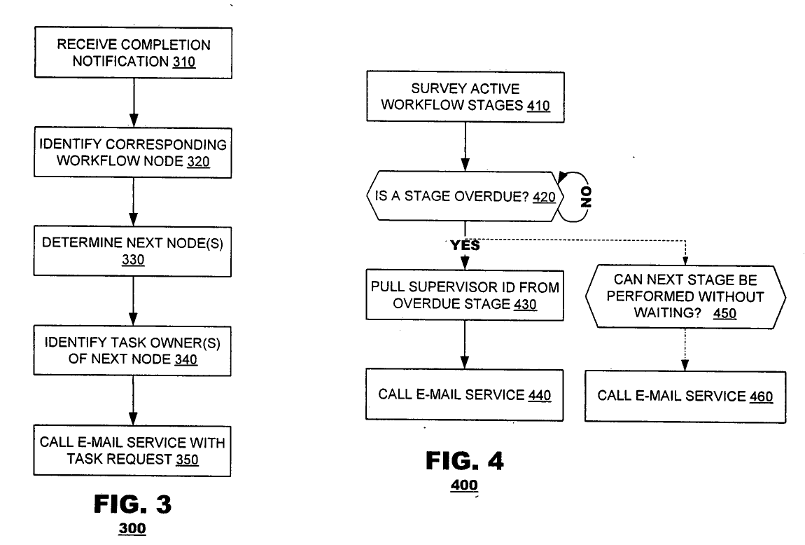

FIG. 3 illustrates a method for providing e-mail notification for a computer system 300 according to an embodiment of the present invention. The method 300 may receive a completion notification from a first user terminal indicating that an active workflow stage has been completed (box 310). Using information included in the notification, the method 300 may identify a workflow related to the completed stage and mark the stage as completed (box 320). As mentioned previously, the workflow may map predefined business processes or tasks and may include useful information in performing the workflow. The method 300 may then refer to the workflow to identify one or more next stages to be performed (box 330). The method 300 also may add a timestamp to the identified next stage(s) indicating that they have become active. From the workflow, the method 300 may determine who will perform operations of the identified next stage(s) (box 340). The method 300 may then send notifications to the identified operator(s) (box 350).

FIG. 4 illustrates a method for providing e-mail notification for a computer system 400 according to another embodiment of the present invention. In this embodiment, the method 400 may send a notification to a workflow's supervisor if a stage is overdue. The method 400 may review all active stages of active workflows (box 410). The method 400 may determine whether a stage is overdue by, for example, comparing the task due date with the start date (box 420). If so, the method 400 may retrieve supervisor ID (box 430) and send a notification to the supervisor indicating that the stage is overdue (box 440). Alternatively, the method 400 may determine whether the next stage may be performed without waiting for the overdue stage to be complete (box 450). If so, the method 400 may send a notification to the supervisor and/or the next task owner (box 460). The method 400 may repeat this process for each and every active stage of all active workflows. According to an embodiment of the present invention, the method 400 may be performed at the supervisor's request and/or automatically at predetermined intervals.

FIG. 3 and FIG. 4 are illustrated as separate methods merely to facilitate presentation of the present invention. Commonly, the collaboration system with e-mail notification support, according to an embodiment of the present invention, may be capable of performing both methods 300 and 400 simultaneously.

Furthermore, according to an embodiment of the present invention, the collaboration system with e-mail notification support also may perform a routine check on the quality of completed tasks and send results to its users. The collaboration system may generate and send workflow progress reports at predetermined stages or intervals. Additionally, the collaboration system may monitor and report any exceptions or errors detected during execution of the workflow.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A computer system, comprising:
an e-mail server; and
a workflow server comprising:
a repository storing a workflow having a plurality of stages, each stage defining a task to be performed, an operator for the task, and a next task, the workflow identifying one of the tasks as a current task, and
a workflow engine to manage operation of the workflow, wherein responsive to a notification that the current task is completed, workflow server is to identify a next open task and cause the email server to notify the next task owner that the next task has become active.

2. The computer system of claim 1, wherein each of the stages define a due date of the task and a supervisor.

3. The computer system of claim 1, wherein the plurality of stages are to be executed consecutively.

4. The computer system of claim 1, wherein two or more of the plurality of stages are to be executed in parallel.

5. The computer system of claim 1, wherein the workflow engine is to identify the next task and the operator of the next task from the workflow when the e-mail notification is received from the first user terminal.

6. The computer system of claim 1, wherein if the workflow engine receives notification that the current task is completed, the workflow engine is to automatically identify a next open task and cause the email server to notify the next task owner that the next task has become active.

7. A workflow manager, comprising:
a storage having defined therein a workflow, the workflow having a plurality of stages, each stage defining a current task to be performed, a task owner, and a next task;
a workflow engine to manage operation of the workflow; and
an e-mail service for exchanging emails with user terminals if called for by the workflow engine;
wherein, upon receipt of a task completion notification, the workflow engine is to identify the next task from the workflow and send a new e-mail notification to an owner of the next task indicating that the next task has become active.

8. The workflow manager of claim 7, wherein each of the stages define a due date of the task and a supervisor.

9. The workflow manager of claim 7, wherein the plurality of stages are to be executed consecutively.

10. The workflow manager of claim 7, wherein two or more of the plurality of stages are to be executed in parallel.

11. The workflow manager of claim 7, wherein the workflow engine is to identify the next task and the operator of the next task from the workflow when the e-mail notification is received from the first user terminal.

12. The workflow manager of claim 7, wherein the workflow engine is to generate the new e-mail notification automatically upon receipt of the task completion notification.

13. A workflow management method, comprising:
responsive to a task completion notification, opening a workflow corresponding to the notification, the workflow defining tasks to be performed and task owners;
determining a next task to be performed from the workflow;
identifying a task owner of the next task from the workflow; and
calling an e-mail service with a task request for the next task.

14. The method of claim 13, further comprising receiving the task completion notification from a first task owner.

15. The method of claim 13, further comprising sending a new notification to a next task owner indicating that the next task has become active.

16. The method of claim 13, wherein the workflow has a plurality of stages, each stage defining a current task to be performed, an operator for the task, and a next task.

17. The method of claim 16, wherein each of the stages define a due date of the task and a supervisor.

18. The method of claim 16, wherein the plurality of stages are to be executed consecutively.

19. The method of claim 16, wherein two or more of the plurality of stages are to be executed in parallel.

20. A workflow management method, comprising:
surveying active workflow stages of a workflow, the workflow having a plurality of workflow stages, each workflow stage defining a task to be performed, a due date, and a supervisor;
determining if any of the active workflow stages is overdue;
if an active workflow stage is overdue, identifying the supervisor of the workflow stage from the workflow; and
calling an e-mail service to send an e-mail notification to the identified supervisor of the workflow stage.

21. The method of claim 20, wherein each of the workflow stages defines a task owner and a next task.

22. The method of claim 20, wherein the plurality of stages are to be executed consecutively.

23. The method of claim 20, wherein two or more of the plurality of stages are to be executed in parallel.
